(19) United States
(12) Patent Application Publication
(10) Pub. No.: US 2016/0136622 A1
(43) Pub. Date: May 19, 2016

(54) MONOLITHIC STRUCTURED CATALYST FOR CARBON MONOXIDE GASE-PHASE COUPLING TO DIALKYL OXALATE & PREPARATION METHOD AND APPLICATION THEREOF

(71) Applicants: Xinbin Ma, Tianjin (CN); Yujun Zhao, Tianjin (CN); Baowei Wang, Tianjin (CN); Shengping Wang, Tianjin (CN); Jing Lv, Tianjin (CN); Zhenghua Li, Tianjin (CN)

(72) Inventors: Xinbin Ma, Tianjin (CN); Yujun Zhao, Tianjin (CN); Baowei Wang, Tianjin (CN); Shengping Wang, Tianjin (CN); Jing Lv, Tianjin (CN); Zhenghua Li, Tianjin (CN)

(21) Appl. No.: 15/003,804

(22) Filed: Jan. 22, 2016

Related U.S. Application Data
(63) Continuation-in-part of application No. 13/701,508, filed on Jan. 13, 2013, now abandoned.

(30) Foreign Application Priority Data
Jun. 4, 2010 (CN) 201010191579.6
Jun. 4, 2010 (CN) 201010191580.9

(51) Int. Cl. B01J 23/89; B01J 37/04; B01J 37/00; B01J 35/04; B01J 37/02

(52) U.S. Cl. CPC B01J 23/8906; B01J 23/8986; B01J 35/04; B01J 37/0242; B01J 37/0236; B01J 37/0009; B01J 37/04

(57) ABSTRACT

Provided was a monolithic catalyst for synthesizing an oxalate by carbon monoxide (CO) gaseous-phase coupling, a preparation method and the use thereof. In the catalyst, a ceramic honeycomb or a metal honeycomb was used as skeletal carrier, metal oxides were used as a carrier coating, precious metals Pt, Pd, Ir, Rh were used as active ingredients, as well as Fe, Co, Ni were used as additives, wherein the carrier coating accounts for 5 to 50 wt. % of the honeycomb carrier; the active ingredients of the catalyst account for 0.1 to 5 wt. % of the carrier coating; the additives of the catalyst account for 0.3 to 10 wt. % of the carrier coating; and the atomic ratio of the active ingredients to the additives was 0.1 to 3. the reaction for synthesizing the oxalate was carried out in a fixed bed reactor, wherein, N2 was used as a carrier gas. The volume ratio of N2:CO:Alkyl nitrite was 20-80:5-60:10-40, and the retention time was 0.5-10 s.

### CROSS-REFERENCE TO RELATED APPLICATIONS

This application is a continuation in part of application Ser. No. 13/701,508, filed Jan. 13 2013, now pending, which is the National Stage of International Application No. PCT/CN2011/075018, filed May 31 2011, and further claims priority benefits to Chinese Patent Application No. 201010191579.6 and 201010191580.9 filed Jun. 4, 2010. The content of the aforementioned applications, including any intervening amendments thereto, is incorporated herein by reference.

### FIELD OF THE INVENTION

This invention involves the dialkyl oxalate syntheses, especially a monolithic catalyst and its preparation for carbon monoxide gas-phase coupling to dialky oxalate, and the production process of carbon monoxide gas-phase coupling to dialky oxalate catalyzed by the monolithic catalyst, producing method of dialkyl oxalate by CO gaseous phase coupling using this monolithic catalyst thereof.

### BACKGROUND OF THE INVENTION

Nowadays, with the petroleum resource of the world increasingly exhausted, the technologies for synthesizing ethylene glycol(EG) from coal or natural gas material have a very important practical significance. And the technology was widely acknowledged as a significant C1 chemical technology owing to its scientific raw material route and reasonable resource utilization. Dialkyl oxalate was considered as a crucial intermediate product in synthesizing EG, and the synthetic technology of dialkyl oxalate was one of the core technologies in synthesizing EG from coal or natural gas. Besides, dialkyl oxalate was also crucial organic chemical materials, which was widely used in fine chemical engineering to produce all sorts of dyes, medicine, important solvents, extractants, and various kinds of intermediate products.

There were many disadvantages in traditional technology of dialkyl oxalate production, such as high cost, huge energy consumption, serious pollution and unreasonable raw material utilization. At present, one relatively advanced method was alcohol oxidization carbonylation, especially in the system of CO gas-phase coupling to dialky oxalate, we introduce nitrous acid ester(RONO, R for alkyl) as oxygen carrier during gaseous alcohol oxidization carbonylation, making the reaction conducting under mild condition. Nitric oxide generated during reaction process can react with alcohol and oxygen to form alkyl nitrite, thus the whole technology became a self-sealing and cyclic system without the three wastes. The reaction equations were described as follows:

2RONO+2CO→(COOR)₂+2NO Coupling reaction:

2NO+2ROH+1/2O₂→2RONO+H₂O Regeneration reaction:

This method owns many advantages such as extensive raw material source, fine atom economy, moderate reaction condition, less energy consumption, pollution-free process, high product selectivity and quality. Due to its clean production technology, obvious economic and social benefits, the process has attracted widespread concern all over the world. At present, this process was under research or industrial development stage. Some advancement has been acquired in catalyst preparation, activity, support effect and operation conditions. Nevertheless, noble metal palladium was generally used as active component of catalysts, which was expensive and increased the production cost of dialkyl oxalate, reducing the economic efficiency of the technology route consequently. Monolithic structured catalyst has neat parallel longitudinal channels, lower pressure drop and benefit the operation at higher space velocity. It was characterized by small reactor volume, whole assembly, easy replacement, fine mass-transfer effect, low loading of active component and high activity. The application of the monolithic structured catalysts was gained more and more attention in gas-solid or gas-liquid-solid heterogeneous reaction in recent years. However, no literature about monolithic structured catalyst research has been reported with regard to dialkyl oxalate production from CO gaseous phase coupling.

### SUMMARY OF THE INVENTION

One purpose of this invention is provided a kind of monolithic catalyst for carbon monoxide gas-phase coupling to dialky oxalate. This kind of monolithic catalysts reduced dosage of precious metal and had high catalytic activity as well as low cost. It provided a new route for dialkyl oxalate production from coal or natural gas, which can greatly promote the industrialization for the technology of carbon monoxide gas-phase coupling to dialkyl oxalate.

Another purpose of this invention is to offer a preparation method of the monolithic catalyst for carbon monoxide gas-phase coupling to dialkyl oxalate. Use dip-coating method to load washcoat on cordierite ceramic honeycomb support, alkaline solution and the H₂ or CO atmosphere were introduced to treat the coated honeycomb support, then, the catalytic activity can be elevated. Meanwhile, active components of this catalyst were confined to the washcoat. The coating was so thin that diffusion resistance was reduced and the mass-transfer efficiency of reactants between gas-solid or gas-liquid-solid phase was elevated, the contact area between reactants and catalyst was also enlarged. Thus the catalytic ability of active components was enhanced.

This invention also aimed at providing a method for carbon monoxide gas-phase coupling to dialkyl oxalate using the monolithic catalyst. The use of the monolithic catalyst rather than traditional pellet catalyst can reduce the pressure drop of the catalyst bed and promote the production capability of dialkyl oxalate for single set of equipment. At the same, time, the depletion of the catalyst, resulting from the abrasion during packing process and reaction process, can also be minimized so that the use-cost of the catalyst can be reduced. This invention could be able to realize large-scale engineering application due to its high catalytic activity, low cost, easy replacement, etc.

### DETAILED DESCRIPTION OF THE INVENTION

Provided was the monolithic structured catalyst for carbon monoxide gas-phase coupling to dialkyl oxalate. In the catalyst, a ceramic honeycomb or a metal honeycomb was used as skeletal carrier, metal oxides were used as a carrier coating, precious metals Pt, Pd, Ir, Rh were used as active components, as well as Fe, Co, Ni were used as additives.

Specific preparation procedure of the catalyst was as follows:

Metal nitrate, hydroxide or oxide were blended with dilute nitric acid; then the mixture was ball milled in a ball mill equipment to prepare ball-milling slurry for coating the support; the washcoat was loaded on ceramic or metal honeycomb supports use dip-coating method with ball-milling slurry; the washcoated support was dried and calcined in a muffle furnace to form metal oxide washcoat; then the washcoated support calcined was impregnated in the precursor solutions of active components and additive to load active components and additive: the impregnated support was dried and finally treated in H₂ or CO atmosphere.

In this invention, the components of the metal oxide washcoat were selected from the following oxides: Al₂O₃, SiO₂, ZrO₂, TiO₂, Fe₂O₃, La₂O₃, CuO, ZnO, Cr₂O₃, GaO, BaO, CaO, MgO, MnO. Or

In this invention, the components of the metal oxide washcoat were selected from the following oxides: Al₂O₃, SiO₂, ZrO₂, TiO₂, Fe₂O₃, La₂O₃, CuO, ZnO, Cr₂O₃, CaO, BaO, CaO,

In this invention, the active ingredient was selected from the precious metal Pt, Pd, Ir, Rh and mixtures thereof.

In this invention, the additive of the monolithic structured catalyst for synthesizing an oxalate by carbon monoxide(CO) gaseous-phase coupling was selected from the Fe, Co, Ni and mixtures thereof.

In this invention, the additive of the monolithic structured catalyst for synthesizing an oxalate by carbon monoxide(CO) gaseous-phase coupling also includes Cu or Ce.

In this invention for the monolithic structured catalyst, the washcoat on the carrier accounts for 5 to 50 wt. % of the honeycomb carrier; the active ingredients of the catalyst account for 0.1 to 5 wt. % of the washcoat on the carrier; the additives of the catalyst account for 0.03 to 10 wt. % of the washcoat on the carrier; and the atomic ratio of the active ingredients to the additives was 0.01 to 5.

In this invention for the monolithic structured catalyst, the washcoat on the carrier accounts for 5 to 50 wt. % of the honeycomb carrier; the active ingredients of the catalyst account for 0.1 to 5 wt. % of the washcoat on the carrier; the additives of the catalyst account for 0.3 to 10 wt. % of the washcoat on the carrier: and the atomic ratio of the active ingredients to the additives was 0.1 to 5.

In this invention for the monolithic structured catalyst, the washcoat on the carrier accounts for 5 to 30 wt. % of the honeycomb carrier; the active ingredients of the catalyst account for 0.1 to 2 wt. % of the washcoat on the carrier; the additives of the catalyst account for 0.3 to 6 wt. % of the washcoat on the carrier; and the atomic ratio of the active ingredients to the additives was 0.1 to 3.

This invention provided the preparation method of monolithic structured catalyst for carbon monoxide gas-phase coupling to dialkyl oxalate. It was characterized that the monolithic catalyst preparation method comprising the steps of:
1) Preparation of the ball milling slurry: Mix one or various kinds of metal nitrate, hydroxide or oxide; add dilute nitric acid into the mixture; then adjust the pH of the mixture in the range of 1 to 4; finally the mixture was ball milled for 1 to 48 hours to get the ball milling slurry for the coating of the supports.
2) Washcoat loading: The washcoat was loaded on ceramic or metal honeycomb supports use dip-coating method with ball-milling slurry, followed by a drying process; one or multiple dip-coating was performed to meet the standard loading; finally calcination was performed at 900-1300° C. for 1-12 hours to form washcoat.
3) Active components and additive loading: Coated support was impregnated into precursor solutions with one or various active components and additives, after a drying process, the catalyst was treated with H₂ or CO atmosphere for 1-10 hours to get the very catalyst we wanted,

This invention provides the preparation method of monolithic catalyst for the reaction of CO gaseous phase coupling to dialkyl oxalate. The specific procedures were as follows:
1) Preparation of the ball milling slurry: Mix one or various kinds of metal nitrate, hydroxide or oxide; add dilute nitric acid of 1-15 wt. % into the mixture; then adjust the pH of the mixture in the range of 1 to 4; finally the mixture was ball milled for 3 to 20 hours to get the bail milling slurry for the coating of the supports.
2) Washcoat loading: The washcoat was loaded on cordierite ceramic honeycomb support or metal honeycomb support use dip-coating method with ball-milling slurry followed by drying at 70-130° C. for 2-4 hours, the coated support was calcined in a furnace at 900-1200° C. for 1-12 hours to form washcoat, the washcoat loading accounts for 5-50 wt. % of honeycomb support, multiple dip-coating must be performed to get higher washcoat loading.
3) Active components loading: Coated support was impregnated into precursor solutions with one or various active components and additives for 3 minutes to 12 hours to load the active components and additives, then the impregnated honeycomb support was drying at 70-130° C. for 1-12 hours, finally, the catalyst was treated with H₂ or CO atmosphere at 400-800° C. for 1-10 hours to get the very catalyst we wanted.

In the above procedure 3, the impregnated washcoat with active components and additive should be dipped in the 0.01-2M alkaline solution for 0.5-24 hours after drying.

The alkaline solution was selected from NaOH, KOH, Na₂CO₃, K₂CO₃, NaHCO₃, KHCO₃ and mixtures thereof.

The precursors of active components used in procedure 3 as selected from palladium chloride, palladium bromide, platinum chloride, rhodium chloride, palladium nitrate, platinum nitrate, palladium acetate, rhodium acetate. Palladium chloride and palladium acetate were preferred. Salts of platinum group can be used singly or in combination.

The precursors of additive used in procedure 3 were selected from ferric trichloride, cobalt bromide, ferric nitrate, nickel nitrate, cobalt acetate, nickel acetate and mixtures thereof.

The monolithic catalyst of this invention was used in reaction of CO gaseous coupling to dialkyl oxalate which can be dimethyl oxalate or diethyl oxalate or mixtures thereof.

This invention provides the production method of dialkyl oxalate by CO gaseous phase coupling using the very monolithic catalyst. The method includes the following steps: the reaction for synthesizing the oxalate was carried out in a fixed bed reactor, the catalyst bed was filled with the monolithic structured monolithic catalyst supporting noble metal, the react pressure was 0.1-2 MPa, the reaction temperature was 80-200° C., N₂ was used as carrier gas. CO and gasified alkyl nitrite were introduced into the reactor and react on the monolithic structured catalyst to produce dialkyl oxalate, The volume ratio of N₂:CO:Alkyl nitrite was 20-80:5-80:10-40, and the retention time was 0.5-10 s.

The method in this invention, the catalyst bed was filled by a monolithic catalyst loaded with precious metal.

The method in this invention, the reaction pressure was 0.1-1.2 MPa and reaction temperature was 90-150° C.

The method in this invention, the volume ratio of the feed gas was: N₂:CO:alkyl nitrite to be 20-80:5-60:10-40. The retention time was 1-10 s.

The method in this invention, the volume ratio of the feed gas was: N₂:CO:alkyl nitrite is to be 20-80:5-60:5-10.

The method in this invention, alkyl nitrite was selected from methyl nitrite or ethyl nitrite or both of them.

Compared with general technology, this invention includes the following characteristics:
1. The monolithic catalyst in this invention was applied to dialkyl oxalate production from CO gaseous coupling for the first time, giving rise to a brand new idea for developing catalyst used for dialkyl oxalate production from CO gaseous coupling.
2. In the monolithic catalyst preparation, Alkali treatment was introduced to improve the interaction between active components and supports, which effectively enhanced catalytic activity in the reaction of CO coupling to dialkyl oxalate.
3. In the synthesis of dialkyl oxalate by carbon monoxide (CO) gas-phase coupling, Compared with pellet catalyst, the monolithic catalyst in this invention greatly reduces the internal diffusion resistance, because the active components of the catalyst were mainly concentrated on the ultra-thin washcoat. Consequently, this monolithic catalyst elevated the mass-transfer efficiency of reaction stuff between gas and solid phase and reduced the amount of precious metals (far less than conventional pellet catalyst for at least 86%). Therefore, catalyst cost can be vastly reduced without affecting reaction activity. Thus, economical efficiency was greatly improved in dialkyl oxalate production from CO gas-phase coupling.
4. Compared with pellet catalyst in the reaction of CO gaseous coupling to dialkyl oxalate, this monolithic catalyst can reduce the pressure drop of the catalyst bed and decreased energy depletion. Moreover, it was suitable for the reaction in the catalyst bed with higher height-diameter ratio. Thus, the production ability of dialkyl oxalate for single equipment can be substantially enhanced and the operation cost can be reduced.

Hence, in this invention, the monolithic structured catalyst used for the coupling of CO to dialkyl oxalate possessed both novelty and economic efficiency. It provide a new technology route for synthesizing dialkyl oxalate from coal or natural gas, and promote engineering realizing of dialkyl oxalate production from CO coupling.

### BRIEF DESCRIPTION OF THE. DRAWINGS

FIG. 1 was the appearance map of the honeycomb ceramics and be monolithic catalyst coating with active components, the ordered parallel channel structure can be observed.

FIG. 2 presented the structure diagrams of single pore in the monolithic catalyst.

FIG. 3 showed the SEM image of single-wall structure of the monolithic catalyst.

FIG. 4 showed the distribution map of the elements from the single-walled cross-section of monolithic catalyst.

FIG. 5 showed the stability date of the monolithic catalyst for synthesizing dialkyl oxalate by CO gase-phase coupling before and after the modification with additive.

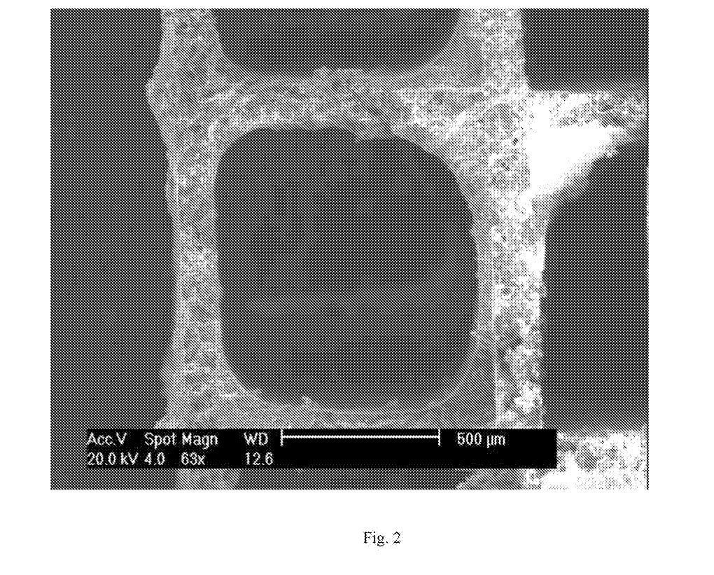

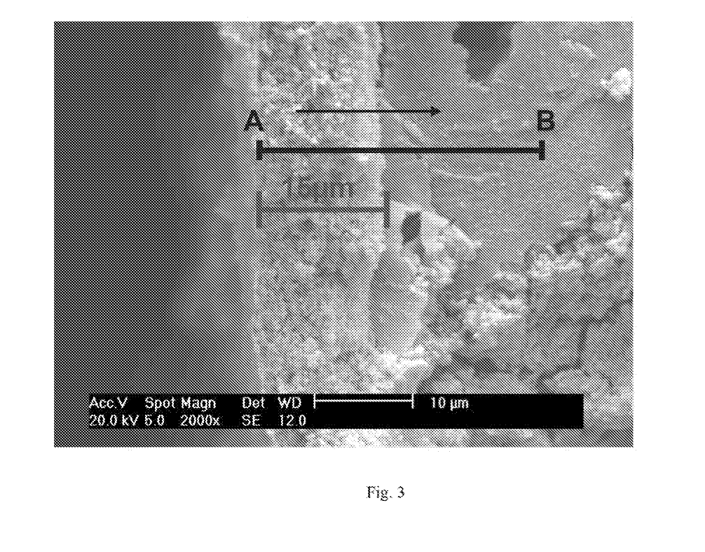

The meaning of the symbol in FIG. 2 and FIG. 3:

ACC. V—acceleration voltage; Spot—electron beam size; Magn—magnification factor; Det—detector; SE—secondary electron; WD—working distance

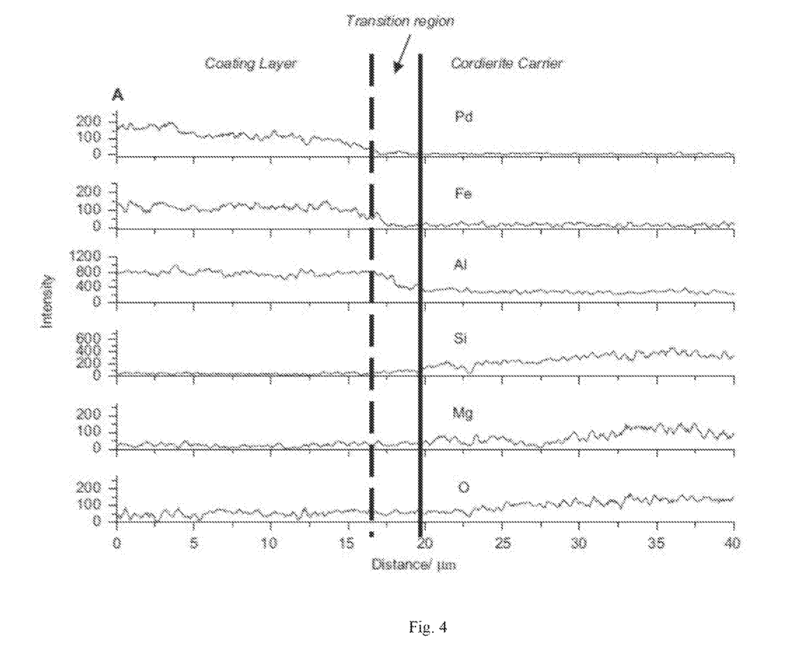

The FIG. 4 was the element distribution from point A to point B at the surface of cross-section of one singer wall for the monolithic catalysts in FIG. 3, obtained by EDS analyze.

The following examples illustrate the present invention more specifically.

### EXAMPLE 1

### Preparation of the Wash Coating Slurry

12.5 grams of γ-Al₂O₃, 3.5 grams of AlOOH, 6.5 grams of Al(OH)₃, 8.0 grams of Al(NO₃)₃ and 100 ml 10 wt. % dilute nitric add were weighted and mixed together, then the mixed material was ball milled at the rotating speed of 200 rpm for 16 hours to get the alumina slurry(planetary ball mill XQM-2L,NanJingShunChi for use)

### Preparation of the Catalyst

The cordierite ceramic honeycomb with 400 cells per square inch (025 mm×25 mm) was calcined at 700° C. for 2 hours to remove the organic impurities, then alumina washcoat was loaded via the conventional dip-coating method with the above alumina slurry. Then the resulting coated honeycomb was dried in microwave and weighted. Several times dip-coating were performed until the Al₂O₃ washcoat loading reach 20%. The coated support was calcined in a furnace with the temperature raised to 1200° C. and maintain at this temperature for 4 hours. Then, the coated support was impregnated in PdCl₂—FeCl₃ solutions far 5 minutes, the concentrations of PdCl₂and FeCl₃ in the solution were 0.2M and 0.13M, respectively. The impregnated catalyst was dried, followed by a treatment in H₂ at 500° C. for 4 hours. The obtained catalyst can be denoted as 1.0% Pd—Fe/20% α-Al₂O₃/Cordierite (atomic ratio of Pd/Fe was 1.5:1) with Pd content of 10 wt. % (relative to Al₂O₃ washcoat) and Pd/Fe atomic ratio of 1.5:1.

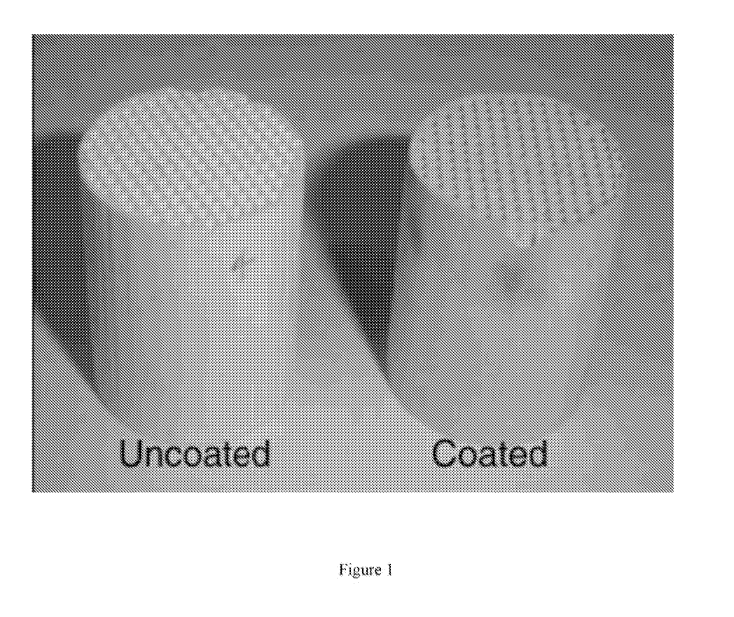

FIG. 1 showed the appearance map of the honeycomb ceramics and the monolithic catalyst loaded with washcoat and active components, where the ordered parallel channel structure can be observed. FIG. 2 presented the structure diagrams of single pore in the monolithic catalyst. FIG. 3 showed the SEM image of single-wall structure of the monolithic catalyst, where the Al₂O₃ washcoat was found mainly attached at the outside surface of honeycomb substrate. FIG. 4 showed the distribution map of the elements from the single-walled cross-section of monolithic catalyst (scanning from the orientation of A to B shown in FIG. 3). Seen from the distribution of Al element, it was found that the Al₂O₃ washcoat mainly focus at the outside surface of honeycomb substrate with thickness of 15 μm. While the active component Pd was evenly distributed in the wash-coat layer, and rarely entered into the honeycomb substrate, presenting an egg-shell like distribution which may greatly reduce the internal diffusion resistance significantly.

### Synthesis Method of Oxalate

The above prepared monolithic catalyst of 12 ml as installed into a fixed bed reactor, after purging the system with nitrogen, CO and methyl nitrite were preheated and introduced into the system to synthesis dimethyl oxalate on the monolithic catalyst. The reaction was carried out at 110° C. and 0.1 MPa. The feed volume ratio of N₂:CO:methyl nitrite was kept at 50:30:20 and residence time was 1.5 seconds. Results of the reaction were shown in table 1.

### EXAMPLE 2

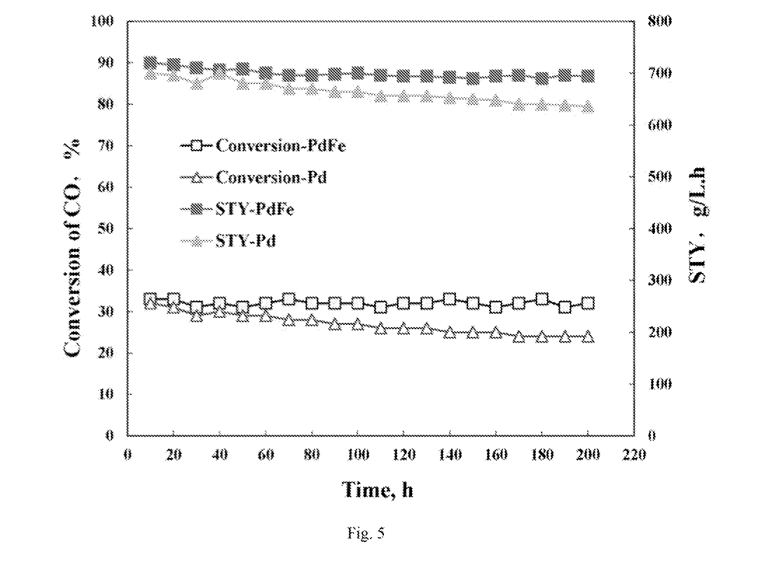

12 ml of the catalyst prepared according to Example 1 was installed into a fixed bed reactor, after purging the system with nitrogen, CO and methyl nitrite were preheated and introduced into the system to synthesis dimethyl oxalate on the monolithic catalyst. The reaction was carried out at 120° C. and 0.25 MPa. The feed volume ratio of N₂:CO:methyl nitrite was kept at 50:30:20 and residence time was 7.5 seconds. The reaction was performed for 200 hours. Results of the reaction were shown in FIG. 5. As can be seen from FIG. 5, the monolithic catalyst modified with additive presented much higher stability.

### COMPARATIVE EXAMPLE 1

### Preparation of Catalysts

The A catalyst was prepared in the same manner as Example 1, except using PdCl₂ solution of 0.2M in place of the mixed solution of PdCl₂ and FeCl₃ during the impregnation of the active components. The obtained catalyst can be denoted as 1.0% Pd/20% α-Al₂O₃/Cordierite with Pd content of 1.0 wt. % (relative to Al₂O₃ washcoat).

Oxalate was synthesized in the same manner as Example 2, and the results were listed in FIG. 5.

### EXAMPLE 3

The catalyst was prepared in the same manner as Example 1, except using the ceramic honeycomb of cordierite with 600 cells per square inch (φ25 mm×25 mm) as the carrier. The obtained catalyst can be denoted as 1.0% Pd—Fe/20% α-Al₂O₃/Cordierite (atomic ratio of Pd/Fe was 1.5:1) with Pd content of 1.0 wt. % (relative to Al₂O₃ washcoat) and Pd/Fe atomic ratio of 1.5:1. Oxalate was synthesized in the same manner as Example 1, and the results were listed in Table 1.

### EXAMPLE 4

The catalyst was prepared in the same manner as Example 1, except the milling time was 4.5 hours. The obtained catalyst can be denoted as 1.0% Pd—Fe/20% α-Al₂O₃/Cordierite (atomic ratio of Pd/Fe was 1.5:1). Oxalate was synthesized in the same manner as Example 1, and the results were listed in Table 1.

### EXAMPLE 6

The catalyst was prepared in the same manner as Example 1, except the milling, time was 9 hours. The obtained catalyst can be denoted as 1.0% Pd—Fe/20% α-Al₂O₃/Cordierite (atomic ratio of Pd/Fe was 1.5:1). Oxalate was synthesized in the same manner as Example 1, and the results were listed in Table 1.

### EXAMPLE 6

The catalyst was prepared in the same manner as Example 1, except the milling time was 36 hours. The obtained catalyst can be denoted as 1.0% Pd—Fe/20% α-Al₂O₃/Cordierite (atomic ratio of Pd/Fe was 1.5:1). Oxalate was synthesized in the same manner as Example 1, and the results were listed in Table 1.

### EXAMPLE 7

The catalyst was prepared in the same manner as Example 1, except diluting the slurry to 0.8 times to get the Al₂O₃ washcoat content of 5% and replacing the molar concentration of PdCl2 and FeCl₃ with 0.2M and 0.1M respectively. The obtained catalyst can be denoted as 1.0% Pd—Fe/5% α-Al₂O₃/Cordierite (atomic ratio of Pd/Fe was 2:1) with Pd content of 1.0 wt. % (relative to Al₂O₃ washcoat) and Pd/Fe atomic ratio of 2:1. Oxalate synthesized in the same manner as Example 1, and the results were listed in Table 1.

### EXAMPLE 8

The catalyst was prepared in the same manner as Example 1, except diluting the slurry to 0.8 times and multiple dip-coating to get the Al₂O₃ washcoat content of 10 wt. % and replacing the molar concentration of PdCl₂ and FeCl₃ with 0.2M and 0.1M respectively. The obtained catalyst can be denoted as 1.0% Pd—Fe/10% α-Al₂O₃/Cordierite (atomic ratio of Pd/Fe was 2:1) with Pd content of 1.0 wt % (relative to Al₂O₃ washcoat) and Pd/Fe atomic ratio of 2:1. Oxalate was synthesized in the same manner as Example 1, and the results were listed in Table 1.

### EXAMPLE 9

The catalyst was prepared in the same manner as Example 1, except increasing the dip-coating times in the ball milled slurry to get the Al₂O₃ washcoat content of 30 wt. % and replacing the molar concentration of PdCl₂ and FeCl₃ with 0.2M and 0.067M respectively. The obtained catalyst can be denoted as 1.0% Pd—Fe/30% α-Al₂O₃/Cordierite (atomic ratio of Pd/Fe was 3:1) with Pd content of 1.0 wt. % (relative to Al₂O₃ washcoat) and Pd/Fe atomic ratio of 3:1. Oxalate was synthesized in the same manner as Example 1, and the results were listed in Table 1.

### EXAMPLE 10

The cordierite ceramic honeycomb with 400 cells per square inch (φ25 mm×25 mm) was calcined at 700° C. for 2 hours to remove the organic impurities. Then the ceramic honeycomb carriers was soaked in the alkaline or acidic silica solution via the conventional dip-coating method, followed by drying in microwave to get silica washcoat on the support. Several times dip-coating were performed until the silica washcoat loading reach 20%. The coated support was calcined in a furnace with the temperature raised to 900° C. and maintain at this temperature for 4 hours. Then, the coated support was impregnated in PdCl₂—FeCl₃ solutions for 5 minutes, the concentrations of PdCl₂ and FeCl₃ in the solution were 0.2M and 0.13M, respectively. The impregnated catalyst was dried, followed by a treatment in H₂ at 500° C. for 4 hours. The obtained catalyst can be denoted as 1.0% Pd—Fe/20% SiO₂/Cordierite (atomic ratio of Pd/Fe was 1.5:1) with Pd content of 1.0 wt. % (relative to Al₂O₃ washcoat) and Pd/Fe atomic ratio of 1.5:1. Oxalate was synthesized in the same manner as Example 1, and the results were listed in Table 1.

### EXAMPLE 11

### Preparation of Wash Coating Slurry

15.0 grams of net titanic acid were weighted and 10 mL hydrochloric acid and 10 ml nitric acid were added. The mixture was ball-milled for 16 hours to obtain titanium oxide slurry.

### Preparation of Catalyst

The catalyst was prepared in the same manner as Example 8, except the titanium oxide slurry was used as the precursor of the washcoat. The obtained catalyst can be denoted as 1.0% Pd—Fe/20% TiO₂/Cordierite (atomic ratio of Pd/Fe was 1.5:1).

### Synthesis of Oxalate

Oxalate was synthesized in the same manner as Example 1 and the results, were listed in Table 1.

### EXAMPLE 12

### Preparation of Wash Coating Slurry

16.5 grams of Zr(OH)₄, 15.0 grams of Zr(NO₃)₄.5H2O and 3.0 grams of ZrO₂ were weighted and 50 mL nitric acid was added. The mixture was ball-milled for 16 hours to obtain zirconium oxide slurry.

### Preparation of Catalyst

The catalyst was prepared in the same manner as Example 8, except the zirconium oxide slurry was used as the precursor of the washcoat. The obtained catalyst can be denoted as 1.0% Pd—Fe/20% ZrO₂/Cordierite (atomic ratio of Pd/Fe was 1.5:1).

### Synthesis of Oxalate

Oxalate was synthesized in the same manner as Example 1, and the results were listed in Table 1.

### EXAMPLE 13

The catalyst was prepared in the same manner as Example 1, except 1.2 grams of Mg(NO₃)₂ was added into the wash coating slurry. The obtained catalyst can be denoted as 1.0% Pd—Fe/20% Al₂O₃.MgO/Cordierite (Pd/Fe atomic ratio of 1.5:1). Oxalate was synthesized in the same manner as Example 1, and the results were listed in Table 1.

### EXAMPLE 14

The catalyst was prepared in the same manner as Example 1, except 0.5 grams of Mn(NO₃)₂ was added into the wash coating slurry. The obtained catalyst can be denoted as 1.0% Pd—Fe/20% Al₂O₃.MnO/Cordierite (Pd/Fe atomic ratio of 1.5:1). Oxalate was synthesized in the same manner as Example 1, and the results were listed in Table 1.

### EXAMPLE 16

The catalyst was prepared in the same manner as Example 1, except changing the molar concentration of PdCl₂ and FeCl₃ to 0.02M and 0.013M to get a Pd loading of 0.1 wt. %. The obtained catalyst can be denoted as 0.1% Pd—Fe/20% α-Al₂O₃/Cordierite (atomic ratio of Pd/Fe was 1.5:1) with Pd content of 0.1 wt. % (relative to Al₂O₃ washcoat) and Pd/Fe atomic ratio of 1.5:1. Oxalate was synthesized in the same manner as Example 1, and the results were lsted in Table 1.

### EXAMPLE 16

The catalyst was prepared in the same manner as Example 1, except changing the molar concentration of PdCl₂ and FeCl₃ to 0.4M and 0.27M to get a Pd loading of 2 wt. %. The obtained catalyst can be denoted as 2% Pd—Fe/20% α-Al₂O₃/Cordierite (atomic ratio of Pd/Fe was 1.5:1) with Pd content of 2 wt. % (relative to Al₂O₃ washcoat) and Pd/Fe atomic ratio of 1.5:1. Oxalate was synthesized in the same manner as Example 1 , and the results were listed in Table 1.

### EXAMPLE 17

The catalyst was prepared in the same manner as Example 1, except changing the molar concentration of PdCl₂ and FeCl₄ to 0.2M and 2M. The obtained catalyst can be denoted as 1% Pd—Fe/20% α-Al₂O₃/Cordiente (atomic ratio of Pd/Fe was 0.1:1) with Pd content of 1.0 wt. % (relative to Al₂O₃ washcoat) and Pd/Fe atomic ratio of 0.1:1. Oxalate was synthesized in the same manner as Example 1, and the results were listed In Table 1.

### EXAMPLE 18

The catalyst was prepared in the same manner as Example 1, except changing the molar concentration of PdCl₂ and FeCl₃ to 0.2M and 0.08M. The obtained catalyst can be denoted as 1.0% Pd—Fe/20% α-Al₂O₃/Cordierite (atomic ratio of Pd/Fe was 2.5:1) with Pd content of 1.0 wt. % (relative to Al₂O₃ washcoat) and Pd/Fe atomic ratio of 2.5:1 Oxalate was synthesized in the same manner as Example 1, and the results were isted in Table 1.

### EXAMPLE 19

The catalyst was prepared in the same manner as Example 1, except changing precursor solution of active component to be a hydrochloric acid solution of Pt(NO₃)₂—Ni(NO₃)₂ (The concentrations of Pt(NO₃)₂ and Ni(NO₃)₂ were 0.02M and 0.02M, respectively.). The obtained catalyst can be denoted as 1.0% Pt—Ni/20% α-Al₂O₃/Cordierite (atomic ratio of Pt/Ni was 1:1) with Pt content of 0.1 wt. % (relative to Al₂O₃ washcoat) and Pt/Ni atomic ratio of 1:1. Oxalate was synthesized in the same manner as Example 1, and the results were listed in Table 1.

### EXAMPLE 20

The catalyst was prepared in the same manner as Example 1, except using hydrochloric acid solution of PdCl₂—IrCl₄—FeCl₃ solution instead of PdCl₂—FeCl₃ (The concentrations of PdCl₂, IrCl₄ and FeCl₃ were 0.15M, 0.03M and 0.13M, respectively.). The obtained catalyst can be denoted as 0.8% Pd-0.1% Ir-Fe/20% α-Al₂O₃/Cordierite ((Pd+Ir)/Fe atomic ratio of 1.2:1). Oxalate was synthesized in the same rmanner as Example 1, and the results were listed in Table 1.

### EXAMPLE 21

The catalyst was prepared in the same manner as Example 1, except a treatment by Na₂CO₃ solution of 0.2M was performed for 6 hours after the impregnation in the hydrochloric acid solution of PdCl₂—FeCl₃ and a subsequent drying process. The obtained catalyst can be denoted as 1.0% Pd—Fe/20% α-Al₂O₃/Cordierite (atomic ratio of Pd/Fe was 1.5:1) with Pd content of 1.0 wt. % (relative to Al₂O₃ washcoat) and Pd/Fe atomic ratio of 1.5:1. Oxalate was synthesized in the same manner as Example 1, and the results were listed in Table 1.

### EXAMPLE 22

The catalyst was prepared in the same manner as Example 21, except alkali treatment by NaOH solution instead of Na₂CO₃ solution. The obtained catalyst can be denoted as 1.0% Pd—Fe/20% α-Al₂O₃/Cordierite (atomic ratio of Pd/Fe was 1.5:1) with Pd content of 1.0 wt. % (relative to Al₂O₃ washcoat) and Pd/Fe atomic ratio of 1.5:1. Oxalate synthesized in the same manner as Example 1, and the results were listed in Table 1.

### EXAMPLE 23

The catalyst was prepared in the same manner as Example 1, except the reduction was performed at 200° C. for 10 hours using CO. The obtained catalyst can be denoted as 1.0% Pd—Fe/20% α-Al₂O₃/Cordierite (atomic ratio of Pd/Fe was 1.5:1) with Pd content of 1.0 wt. %. (Relative to Al₂O₃ washcoat) and Pd/Fe atomic ratio of 1.5:1. Oxalate was synthesized in the same manner as Example 1, and the results were listed in Table 1.

### EXAMPLE 24

Metal honeycomb support (Triangle channel, 400 cpsi, φ25 mm×25 mm) was washed in acetone and ethanol to remove the organic compounds on the surface of the support, followed by washing with deionized water and calcination at 800° C. for 10 hours. Then, the metal honeycomb coat treated was coated with Al₂O₃ ball-milled slurry of alumina as mentioned in Example 1 via the conventional dip coating method and dried in an oven. Several times dip-coating were performed until the Al₂O₃ washcoat loading reach 20%. The coated support was calcined in a furnace with the temperature raised to 1200° C. and maintain at this temperature for 4 hours. Then, the coated support was impregnated in a solution of PdCl₂ and FeCl₃, both concentrations of PdCl₂ and FeCl₃ were 0.2M. The impregnated catalyst was dried, followed by a treatment in H₂ at 500° C. for 4 hours. The obtained catalyst can be denoted as 1.0% Pd—Fe/20% α-Al₂O₃/Metal monolith with Pd content of 1.0 wt. % ((relative to Al₂O₃ washcoat) and Pd/Fe atomic ratio of 1:1. Oxalate was synthesized in the same manner as Example 1 except the use of metal honeycomb support, and the results were listed in Table 1.

### COMPARATIVE EXAMPLE 2

The catalyst was prepared in the same manner as Example 1, except the calcination was performed at 400° C. for 2 hours after impregnating active components and drying. The obtained catalyst can be denoted as 1.0% Pd—Fe/20% α-Al₂O₃/Cordierite (atomic ratio of Pd/Fe was 1.5:1) with Pd content of 1.0 wt. % (Relative to Al₂O₃ washcoat) and Pd/Fe atomic ratio of 1.5:1. Oxalate was synthesized in the same manner as Example 1, and the results were listed in Table 1.

### COMPARATIVE EXAMPLE 3

### Preparation of Wash Coating Slurry

γ-Al₂O₃ powders with 200 meshes was used as the raw material to pre 20% γ-Al₂O₃ suspension, whose pH was adjusted to 5 with dilute nitric acid and the mixture was stirred for 24 hours to obtain alumina slurry for use.

### Preparation of Catalyst

The catalyst was prepared in the same manner as Example 1, except the alumina slurry prepared in this example was used. The obtained catalyst can be denoted as 1.0% Pd—Fe/20% α-Al₂O₃/Cordierite (atomic ratio of Pd/Fe was 1.5:1).

Oxalate was synthesized in the same manner as Example 1; the results were listed in Table 1.

### COMPARATIVE EXAMPLE 4

Granular type α-Al₂O₃ with diameter of φ2-3 mm was used, which was calcined in a furnace with the temperature raised to 1200° C. and maintain at this temperature for 4 hours to obtained the particulate catalyst support. Then, the support was impregnated in hydrochloric acid solution of PdCl₂ and FeCl₃ (concentrations of PdCl₂ and FeCl₃ were 0.02M and 0.013M). The impregnated catalyst was dried, followed by a reduction in H₂ at 500° C. for 4 hours. The obtained catalyst can be denoted as 0.1% Pd—Fe/α-Al₂O₃ with Pd content of 0.1 wt. % and Pd/Fe atomic ratio of 1.5:1. Oxalate was synthesized in the same manner as Example 1 except the use of particulate catalyst, and the results were listed in Table 1.

### COMPARATIVE EXAMPLE 5

The catalyst was prepared in the same manner as Comparative Example 5, except changing the molar concentration of PdCl₂ and FeCl₃ to 0.2M and 0.13M. The obtained catalyst can be denoted as 1.0% Pd—Fe/α-Al₂O₃ with Pd content of 1.0 wt. % (Relative to Al₂O₃ support) and Pd/Fe atomic ratio of 1.5:1. Oxalate was synthesized in the same manner as Example 1, and the results were listed in Table 1.

### EXAMPLE 25

The catalyst prepared in Example 1 was used for the synthesis of diethyl oxalate by CO gaseous coupling at the reaction conditions as follows: temperature at 120° C., pressure at 0.1 MPa, residence time of 1.5 seconds, feed volume ratio of N₂:CO:C₂H₅ONO=40:40:20 and the catalyst dosage of 12 ml. The results were listed in Table 2.

### EXAMPLE 26

The catalyst prepared in Example 1 was used for the synthesis of diethyl oxalate by CO gaseous coupling at the reaction conditions as follows: temperature at 130° C., pressure at 0.3 MPa, residence time of 3 seconds, feed volume ratio of N₂:CO:C₂H₅ONO=40:40:20 and the catalyst dosage of 48 ml. The results were listed in Table 2.

### EXAMPLE 27

The same method as Example 1 was used except the pressure of 0.6 MPa and residence time of 3.6 seconds were adopted. The results were listed in Table 2.

### EXAMPLE 28

The same method as Example 1 was used except be reaction e per tore of 90° C. was adopted. The results were listed in Table 2.

### EXAMPLE 29

The same method as Example 1 was used except the reaction temperature of 150° C. as adopted. The results were listed in Table 2.

### EXAMPLE 30

The same method as Example 1 was used except the feed volume ratio of N₂:CO:methyl nitrite=20:40:40 was adopted. The results were listed in Table 2.

### EXAMPLE 31

The same method as Example 1 was used except the feed volume ratio of N₂:CO:methyl nitrite=40:40:20 was adopted. The results were listed in Table 2.

### EXAMPLE 32

The same method as Example 1 was used except the feed volume ratio of N₂:CO:methyl nitrite=50:40:10 was adopted. The results were listed in Table 2.

### EXAMPLE 33

The same method as Example 1 was used except the feed volume ratio of N₂:CO:methyl nitrite=70:25:5 was adopted. The results were listed in Table 2.

### EXAMPLE 34

The same method as Example 1 was used except the residence time of second was adopted. The results were listed in Table 2.

### EXAMPLE 35

### Preparation of the Wash Coating Slurry

12.5 grams of γ-Al₂O₃, 3.5 grams of AlOOH, 6.5 grams of Al(OH)₃, 8.0 grams of Al(NO₃)₃ and 100 ml 10 wt. % dilute nitric acid were weighted and mixed together, then the mixed material was ball milled at the rotating speed of 200 rpm for 16 hours to get the alumina slurry. (planetary ball mill XQM-2L,NanJingShunChi for use)

### Preparation of the Catalyst

The cordierite ceramic honeycomb with 400 cells per square inch (φ25 mm×25 mm) was calcined at 700° C. for 2 hours to remove the organic impurities, then alumina washcoat was loaded via the conventional dip-coating method with the above alumina slurry. Then the resulting coated honeycomb was dried in microwave and weighted. Several times dip-coating were performed until the Al₂O₃ washcoat loading reach 20%. The coated support was calcined in a furnace with the temperature raised to 1100° C. and maintain at this temperature for 4 hours. Then, the coated support was impregnated in a flowing solutions of PdCl₂—FeCl₃ circulated by a peristaltic pump for 3 minutes, the concentrations of PdCl₂and FeCl₃ in the solution were 0.2M and 0.13M, respectively. The impregnated catalyst was treated in the 0.1M NaOH solution for 10 hours followed by a washing with 500 mL deionized water. Finally the sample was dried at 120° C. for 8 hours followed by a treatment in H₂ at 500° C., for 4 hours. The obtained catalyst can be denoted as 1.0% Pd—Fe/20% α-Al₂O₃/Cordierite (atomic ratio of Pd/Fe was 1.5:1) with Pd content of 1.0 wt. % (relative to Al₂O₃ washcoat) and Pd/Fe atomic ratio of 1.5:1.

### Synthesis Method of Oxalate

The above prepared monolithic catalyst of 12 ml was installed into a fixed bed reactor, after purging the system with nitrogen, CO and methyl nitrite were preheated and introduced into the system to synthesis dimethyl oxalate on the monolithic catalyst. The reaction was carried out at 110° C. and 0.1 MPa. The feed volume ratio of N₂:CO:methyl nitrite was kept at 50:30:20 and residence time was 1.5 seconds. The conversion of CO was 36%, and the space time yield (STY) of DMO was 385 g/L.h.

Provided was a monolithic catalyst for synthesizing an oxalate by carbon monoxide(CO) gas-phase coupling. Compared with the supported particulate catalyst, the monolithic catalyst exhibited excellent catalytic performance of 450 gDMO/L.h (see Example 13), which was high than the particulate catalyst with 409 gDMO/L.h (see Comparative Example 5). The highest space-time yield of oxalate can be achieved to be 920 gDMO/L.h through the modification of the reaction conditions. In addition, the absolute loading of noble metal in the structured catalyst per unit volume only account for 14% of that in particulate catalyst. It's obvious that monolithic catalyst saved more than 86% precious metal, significantly reducing the cost of the catalyst and the production cost of the oxalate. Meanwhile, the monolithic catalyst has neatly ranged parallel channels, larger porosity of the catalyst bed and lower resistance for the reaction stream flowing through the catalyst bed, accelerating the large-scale industrial application of the technology.

TABLE 1
The performance of the catalyst for synthesizing dialkyl oxalate from carbon gaseous coupling

| | | | washcoat | | component | | | | CO | |
|---|---|---|---|---|---|---|---|---|---|---|
| | milling | washcoat | loading/ | Active | loading/ | | | | conversion/ | STY, |
| Catalyst | time/h | composition | wt. % | component | wt. % | Additive | gPd/L | Pd/Fe | % | g/L.h |
| Example 1 | 16 | Al₂O₃ | 20 | Pd | 1 | Fe | 1.14 | 1.5 | 32 | 347 |
| Example 3 | 16 | Al₂O₃ | 20 | Pd | 1 | Fe | 1.14 | 1.5 | 32 | 339 |
| Example 4 | 4.5 | Al₂O₃ | 20 | Pd | 1 | Fe | 1.14 | 1.5 | 27 | 276 |
| Example 5 | 9 | Al₂O₃ | 20 | Pd | 1 | Fe | 1.14 | 1.5 | 29 | 308 |
| Example 6 | 36 | Al₂O₃ | 20 | Pd | 1 | Fe | 1.14 | 1.5 | 33 | 357 |
| Example 7 | 16 | Al₂O₃ | 5 | Pd | 1 | Fe | 0.29 | 2 | 28 | 292 |
| Example 8 | 16 | Al₂O₃ | 10 | Pd | 1 | Fe | 0.57 | 2 | 31 | 324 |
| Example 9 | 16 | Al₂O₃ | 30 | Pd | 1 | Fe | 1.71 | 3 | 39 | 390 |
| Example 10 | | SiO₂ | 20 | Pd | 1 | Fe | 1.14 | 1.5 | 31 | 321 |
| Example 11 | 16 | TiO₂ | 20 | Pd | 1 | Fe | 1.14 | 1.5 | 29 | 300 |
| Example 12 | 16 | ZrO₂ | 20 | Pd | 1 | Fe | 1.14 | 1.5 | 27 | 285 |
| Example 13 | 16 | Al₂O₃•MgO | 20 | Pd | 1 | Fe | 1.14 | 1.8 | 42 | 450 |
| Example 14 | 16 | Al₂O₃•MnO | 20 | Pd | 1 | Fe | 1.14 | 1.5 | 34 | 367 |
| Example 15 | 16 | Al₂O₃ | 20 | Pd | 0.1 | Fe | 0.11 | 1.5 | 16 | 176 |
| Example 16 | 16 | Al₂O₃ | 20 | Pd | 2 | Fe | 2.28 | 1.5 | 34 | 361 |
| Example 17 | 16 | Al₂O₃ | 20 | Pd | 1 | Fe | 1.14 | 0.1 | 28 | 310 |
| Example 18 | 16 | Al₂O₃ | 20 | Pd | 1 | Fe | 1.14 | 2.5 | 33 | 332 |
| Example 19 | 16 | Al₂O₃ | 20 | Pt | 1 | Ni | | 1 | 29 | 301 |
| Example 20 | 16 | Al₂O₃ | 20 | Pd-lr | 0.9 | Fe | | 1.2 | 29 | 301 |
| Example 21 | 16 | Al₂O₃ | 20 | Pd | 1 | Fe | 1.14 | 1.5 | 35 | 385 |
| Example 22 | 16 | Al₂O₃ | 20 | Pd | 1 | Fe | 1.14 | 1.5 | 34 | 370 |
| Example 23 | 16 | Al₂O₃ | 20 | Pd | 1 | Fe | 1.14 | 1.5 | 33 | 355 |
| Example 24 | 16 | Al₂O₃ | 20 | Pd | 1 | Fe | 1.14 | 1 | 32 | 336 |
| Comparative | 16 | Al₂O₃ | 20 | Pd | 1 | Fe | 1.14 | 1.5 | 28 | 300 |
| example 2 | | | | | | | | | | |
| Comparative | | Al₂O₃ | 20 | Pd | 1 | Fe | 1.14 | 1.5 | 19 | 220 |
| example 3 | | | | | | | | | | |

TABLE 2
The performance of the catalyst for synthesizing dialkyl oxalate from carbon gaseous coupling

| | | | | | | Pd | | CO | |
|---|---|---|---|---|---|---|---|---|---|
| | Pressure/ | Temperature/ | N₂:CO:AN | residence | Alkyl | loading | | conversion/ | STY, |
| Catalyst | MPa | ° C. | (v/v/v) | time/s | nitrite | wt. % | gPD/L | % | g/L.h |
| Example 25 | 0.1 | 120 | 40:40:20 | 1.2 | ethyl | 1 | 1.14 | 34 | 420 |
| | | | | | nitrite | | | | |
| Example 26 | 0.3 | 130 | 40:40:20 | 3 | methyl | 1 | 1.14 | 38 | 470 |
| | | | | | nitrite | | | | |
| Example 27 | 0.6 | 110 | 50:30:20 | 3.6 | methyl | 1 | 1.14 | 45 | 920 |
| | | | | | nitrite | | | | |
| Example 28 | 0.1 | 90 | 50:30:20 | 1 | methyl | 1 | 1.14 | 24 | 257 |
| | | | | | nitrite | | | | |
| Example 29 | 0.1 | 150 | 50:30:20 | 1.5 | methyl | | 1.14 | 58 | 808 |
| | | | | | nitrite | | | | |
| Example 30 | 0.1 | 110 | 20:40:40 | 1.5 | methyl | 1 | 1.14 | 50 | 530 |
| | | | | | nitrite | | | | |
| Example 81 | 0.1 | 110 | 40:40:20 | 1.5 | methyl | 1 | 1.14 | 37 | 406 |
| | | | | | nitrite | | | | |
| Example 32 | 0.1 | 110 | 50:40.10 | 1.5 | methyl | 1 | 1.14 | 20 | 215 |
| | | | | | nitrite | | | | |
| Example 33 | 0.1 | 110 | 75:20:5 | 1 | methyl | 1 | 1.14 | 18 | 105 |
| | | | | | nitrite | | | | |
| Example 34 | 0.1 | 110 | 50:30:20 | 1 | methyl | 1 | 1.14 | 22 | 355 |
| | | | | | nitrite | | | | |

We claim:

1. A method for preparing a monolithic structured catalyst for carbon monoxide gas-phase coupling to dialkyl oxalate, comprising:
1) Preparation of the ball milling slurry: Mixing one or various kinds of metal nitrate, hydroxide or oxide: adding dilute nitric acid into the mixture; adjusting the pH of the mixture in the range of 1 to 4; and ball milling the mixture for 1 to 48 hours to get the ball milling slurry for the coating of the supports;
2) Washcoat loading: loading the washcoat on ceramic or metal honeycomb supports using the dip-coating method with ball-milling slurry, followed by a drying process; repeating the dip-coating step until achieving the desired loading; and performing calcination at 900-1300° C. for 1-12 hours to form a washcoat;
3) Active components and additive loading: impregnating the coated support into precursor solutions with one or various active components and additives, after a drying process; and treating the catalyst in a H₂ or CO atmosphere for 1-10 hours.

2. The method according to claim 1, comprising:
1) Preparation of the ball milling slurry: Mixing one or various kinds of metal nitrate, hydroxide or oxide; adding dilute nitric acid of 1-15 wt. % into the mixture: adjusting the pH of the mixture in the range of 1 to 4; and ball milling the mixture for 3 to 20 hours to get the ball milling slurry for the coating of the supports;
2) Washcoat loading: Loading the washcoat on cordierite ceramic honeycomb sup port or metal honeycomb support use the dip-coating method with ball-milling slurry, followed by drying at 70-130° C. for 2-4 hours; and performing calcination at 900-1200° C. for 1-12 hours to form a washcoat, wherein the washcoat loading accounts for 5-50 wt. % of the honeycomb support;
3) Active components loading: Impregnating the coated support into precursor solutions with one or various active components and additives for 3 minutes to 12 hours to load the active components and additives; drying the impregnated honeycomb support at 70-130° C. for 1-12 hours; and treating the catalyst in a H₂ or CO atmosphere at 400-800° C. for 1-10 hours.

3. The method according to claim 1 wherein the impregnated washcoat with active components and additive is treated in the 0.01-2M alkaline solution for 0.5-24 hours after drying.

4. The method according to claim 3, wherein the alkaline solution is selected from NaOH, KOH, Na₂CO₃, K₂CO₃, NaHCO₃, KHCO₃ and mixtures thereof.

5. The method according to claim 1, wherein the precursor of active ingredient in the catalyst is selected from palladium chloride, palladium bromide, chloride platinum and rhodium chloride, palladium nitrate, nitrate platinum, acetate palladium, acetate rhodium or a mixture thereof.

6. The method according to claim 1, wherein the precursor of additive in the catalyst is selected from ferric chloride, cobalt bromide, nitrate iron, nickel nitrate, iron phosphate, cobalt phosphate or cobalt acetate, nickel acetate or a mixture thereof.

7. The method according to claim 1, wherein the skeletal carrier is a ceramic honeycomb or a metal honeycomb, the carrier coating is a metal oxide, the active component is selected from a group consisting of Pt, Pd, Ir, Rh and a mixture thereof, and the additive is selected from a group consisting of Fe, Co, Ni and a mixture thereof;

8. The method according to claim 1, wherein the metal oxide is selected from a group consisting of Al₂O₃, SiO₂, ZrO₂, TiO₂, Fe₂O₃, La₂O₃, CuO, ZnO, Cr₂O₃, GaO, BaO, CaO, MgO, MnO, and a mixture thereof.

9. The method according to claim 1, wherein the washcoat on the carrier accounts for 5 to 30 wt. % of the honeycomb carrier; the active ingredient of the catalyst accounts for 0.1 to 2 wt. % of the washcoat on the carrier; the additive of the catalyst accounts for 0.3 to 6 wt. % of the washcoat on the carrier; and the atomic ratio of the active ingredient to the additive is 0.1 to 3.
